(19) United States
(12) Patent Application Publication
(10) Pub. No.: US 2011/0041356 A1
(43) Pub. Date: Feb. 24, 2011

(54) SPIN DRYING METHOD

(75) Inventors: Jae-Mun Kim, Gyungsangnam-do (KR); Sang-Tae Byun, Busan (KR); Gi-Hyeong Do, Gyungsangnam-do (KR)

Correspondence Address: MCKENNA LONG & ALDRIDGE LLP, 1900 K STREET, NW, WASHINGTON, DC, 20006, US

(73) Assignee: LG ELECTRONICS, INC., Seoul (KR)

(21) Appl. No.: 12/226,004

(22) PCT Filed: Apr. 5, 2007
(86) PCT No.: PCT/KR2007/001677

§ 371 Date: Oct. 28, 2009

(30) Foreign Application Priority Data
Apr. 5, 2006 (KR) 10-2006-0031150
Apr. 5, 2006 (KR) 10-2006-0031151

(51) Int. Cl. F26B 5/08

(52) U.S. Cl. 34/318

(57) ABSTRACT

The present invention discloses a spin drying method using a spin dryer including a tub provided with a drainage passage, and a drum rotatably positioned in the tub, for containing laundry. The spin drying method includes a first step for accelerating the drum containing the laundry from a first rotation speed to a second rotation speed for spin drying, and a second step for finishing the spin drying and stopping the drum. The first step includes a process for determinating continuation of the acceleration. The determination process is conducted in at least one period included in the rotation speed range ranging from the first rotation speed to the second rotation speed.

### TECHNICAL FIELD

The present invention relates to a spin drying method, and more particularly, to a spin drying method including a process for judging continuation of acceleration according to an allowable unbalance value in an acceleration period for increasing a rotation speed of a drum for spin drying.

The present invention relates to a spin drying method, and more particularly, to a spin drying method which can check and correct a quantity of laundry according to a number of times of water supply by reflecting the number of times of water supply in a rinsing process to a laundry quantity sensing process after a drainage process, determine an allowable unbalance value, and spin dry the laundry.

### BACKGROUND ART

FIG. 1 is a diagram showing one example of a conventional spin drying method. A quantity of laundry is sensed. A drum is accelerated to a rotation speed A for sensing unbalance. In a state where the rotation speed A is maintained, the unbalance is firstly sensed. According to the first sensing result, if the unbalance value exists in a normal range, the drum is firstly accelerated to a rotation speed B so as to drain off water from the laundry. When the drum reaches the rotation speed B, the drum is decelerated again to the rotation speed A. The unbalance is secondly sensed at the rotation speed A. According to the second sensing result, if the unbalance value exists in the normal range, the drum is secondly accelerated to a rotation speed C. When the drum reaches the rotation speed C, the drum is decelerated again to the rotation speed A. The unbalance is thirdly sensed at the rotation speed A. According to the third sensing result, if the unbalance value exists in the normal range, the speed is increased to a spin drying speed D to start spin drying.

If the laundry is not normally distributed in the spin drying process, unbalance of the laundry occurs. When the drum is rotated in this unbalance state, the laundry cannot be normally spin dried. Therefore, a washing machine judges whether the unbalance value exists in the appropriate range, and then starts the spin drying.

For example, in the abovementioned spin drying process, the process for detecting the unbalance and judging whether the unbalance is normal can be performed as follows. When a revolution number of the drum is increased to an unbalance sensing revolution number so as to perform the spin drying, the laundry sticks to the inner wall of the drum the to a centrifugal force. In this state, a motor sensor attached to a motor detects a speed of a mover. If the laundry is evenly scattered at the inner wall of the drum, a predetermined force is applied to the motor in the rotation of the drum. However, if the laundry is not evenly scattered but inclined to one side or conglomerated in the drum, namely, if the laundry is eccentrically positioned, a load applied to the motor is not constant, and thus the rotation speed of the drum is not constant either. A control unit can judge whether the unbalance value belongs to the normal range on the basis of a variation amount of the rotation speed of the motor.

The unbalance can be judged according to various methods, such as a method for comparing an applied voltage with a current rotation speed of a drum, a method for maintaining a drum at a predetermined speed and sensing an amplitude, a method for maintaining a drum at a predetermined speed and sensing a number of times of exceeding an allowable amplitude, and a method for measuring a time taken to reach a rotation speed required with regard to an applied voltage.

One example of the conventional art has been disclosed in Korea Laid-Open Patent Gazette 2005-123433.

Meanwhile, the laundry is actually spin dried at a high rotation speed (for example, 1400 rpm). It means that the washing machine roust pass through an acceleration pericd including a resonance rotation speed (for example, 160 to 350 rpm) for the spin drying. In this period, the washing machine may be seriously vibrated. Accordingly, the washing machine has been generally designed to pass through the resonance rotation speed period by rapidly accelerating the drum. In adition, it is difficult to maintain a predetermined rotation speed and measure an unbalance value in this period. There has not yet been suggested an appropriate method for measuring unbalance in this period.

An allowable unbalance value is determined according to a quantity of laundry. For example, the quantity of the laundry can be determined by rotating the drum at a pre-determined rotation speed (for example, 80 rpm) for a predetermined time, and using an accumulated value of an applied voltage.

However, according to the conventional method for sensing the quantity of the laundry, when the laundry includes cloths which may be rolled by rotation of the drum, if the laundry is rolled by rotation of the drum, the quantity of the laundry cannot be precisely measured. As a result, the sensed quantity of the laundry is smaller than the real quantity of the laundry.

Another conventional method for sensing the quantity of the laundry senses the quantity of the laundry according to an amount of re-supplied wash water or a number of times of re-supply. This method indirectly judges the quantity of the laundry.

### DISCLOSURE OF INVENTION

### Technical Problem

An object of the present invention is to provide a spin drying method using an unbalance sensing method conflicted in an acceleration period of a drum.

Another object of the present invention is to provide a spin drying method using an unbalance sensing method conflicted in an acceleration period including a resonance rotation speed of a washing machine.

Yet another object of the present invention is to provide a spin drying method using an unbalance sensing method conducted by dividing an acceleration period of a drum into a plurality of periods.

Yet another object of the present invention is to provide a spin drying method using an unbalance sensing method giving different allowable unbalance values to a plurality of acceleration periods.

Yet another object of the present invention is to provide a spin drying method using an allowable unbalance value based on accurate laundry quantity sensing.

Yet another object of the present invention is to provide a spin drying method determining an allowable unbalance value by using a checked and corrected quantity of laundry.

Yet another object of the present invention is to provide a spin drying method correcting a sensed quantity of laundry after drainage by using a number of times of water supply in a rinsing step, and determining an allowable unbalance value by using the corrected quantity of the laundry.

Yet another object of the present invention is to provide a spin drying method capable of correcting and precisely sensing a quantity of laundry, even if the laundry is rolled in a drum not to be easily measured.

### Technical Solution

The present invention provides a spin drying method using a tub provided with a drainage passage, a drum rotatably positioned in the tub, for containing laundry, and a water supply passage connected to the tub, for supplying wash water into the tub, the spin drying method including: a first step for accelerating the drum containing the laundry from a first rotation speed to a second rotation speed for spin drying, the first step including a determination process for determinating continuation of the acceleration in at least one period included in the rotation speed range ranging from the first rotation speed to the second rotation speed; and a second step for finishing the spin drying and stopping the rotation of the drum.

In one aspect of the present invention, the determination process is performed in at least two periods.

In another aspect of the present invention, the determination process is performed in the at least two periods by using different determination references.

In yet another aspect of the present invention, the rotation speed range includes a resonance rotation speed of a spin dryer.

In yet another aspect of the present invention, the determination process de- terminates continuation of the acceleration by using a variation amount of the rotation speed.

In yet another aspect of the present invention, the spin drying method further includes a step for judging a number of times of water supply using the water supply passage as a prior step to the first step. The first step spin dries the laundry with an available unbalance value reflecting the judged number of times of water supply. Here, the number of times of water supply may or may not include first water supply.

In yet another aspect of the present invention, the spin drying method further includes a step for judging a quantity of laundry prior to the first step.

In yet another aspect of the present invention, the spin drying method further includes a step for draining off wash water through the drainage passage prior to the step for judging the quantity of the laundry.

In yet another aspect of the present invention, the step for judging the quantity of the laundry includes a laundry quantity correction process for correcting the quantity of the laundry by using the judged number of times of water supply.

In yet another aspect of the present invention, when the judged number of times of water supply is over a predetermined value, the laundry quantity correction process corrects the judged quantity of the laundry into a greater quantity.

The present invention provides a spin drying method using a tub provided with a drainage passage, a drum rotatably positioned in the tub, for containing laundry, and a water supply passage connected to the tub, for supplying wash water into the tub, the spin drying method including: a step for judging a number of times of water supply using the water supply passage; and a spin drying step for spin drying the laundry with an allowable unbalance value reflecting the judged number of times of water supply.

In one aspect of the present invention, the spin drying method further includes a step for judging a quantity of laundry prior to the spin drying step.

In another aspect of the present invention, the spin drying method further includes a step for draining off wash water through the drainage passage prior to the step for judging the quantity of the laundry.

In yet another aspect of the present invention, the step for judging the quantity of the laundry includes a laundry quantity correction process for correcting the quantity of the laundry by using the judged number of times of water supply.

In yet another aspect of the present invention, when the judged number of times of water supply is over a predetermined value, the laundry quantity correction process corrects the judged quantity of the laundry into a greater quantity.

### ADVANTAGEOUS EFFECTS

According to the spin drying method of the present invention, the laundry can be stably spin dried by sensing the unbalance in the acceleration period of the drum.

According to the spin drying method of the present invention, the laundry can be stably spin dried by sensing the unbalance in the acceleration period including the resonance rotation speed of the washing machine.

According to the spin drying method of the present invention, the laundry can be stably spin dried by sensing the unbalance by dividing the acceleration period of the drum into the plurality of periods.

According to the spin drying method of the present invention, the laundry can be stably spin dried by sensing the unbalance by giving different allowable unbalance values to the plurality of acceleration periods.

According to the washing method of the present invention, the laundry can be stably spin dried by using the allowable unbalance value based on accurate laundry quantity sensing.

According to the washing method of the present invention, the laundry can be stably spin dried by determining the allowable unbalance value by using the checked and corrected quantity of the laundry.

According to the washing method of the present invention, the laundry can be stably spin dried by correcting the sensed quantity of the laundry after drainage by using the number of times of water supply in the rinsing step, and determining the allowable unbalance value by using the corrected quantity of the laundry.

According to the washing method of the present'invention, even if the laundry is rolled in the drum not to be easily measured, the quantity of the laundry can be corrected and precisely sensed.

### BRIEF DESCRIPTION OF THE DRAWINGS

FIG. 1 is a diagram showing one example of a conventional spin drying method;

FIG. 2 is a drawing view illustrating one example of a washing machine capable of conducting a spin drying method in accordance with the present invention;

FIG. 3 is a drawing view illustrating one example of a motor sensor for sensing rotation of a drum;

FIG. 4 is a diagram showing one example of a method for sensing unbalance in an acceleration period in accordance with the present invention;

FIG. 5 is diagrams showing examples of an acceleration type taken by the drum in the acceleration period;

FIG. 6 is a flowchart showing one example of a spin drying process in accordance with the present invention; and

FIG. 7 is a flowchart showing one example of a spin drying method in accordance with the present invention.

### MODE FOR THE INVENTION

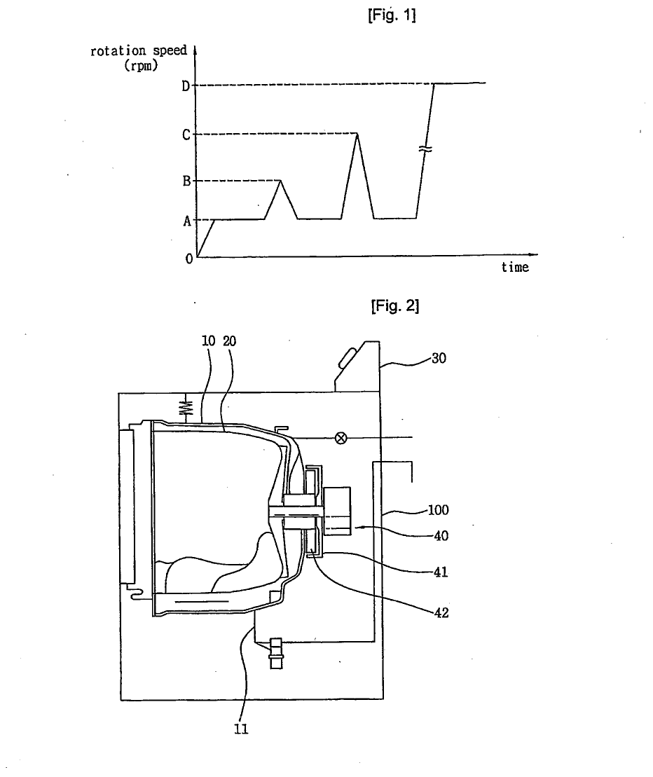

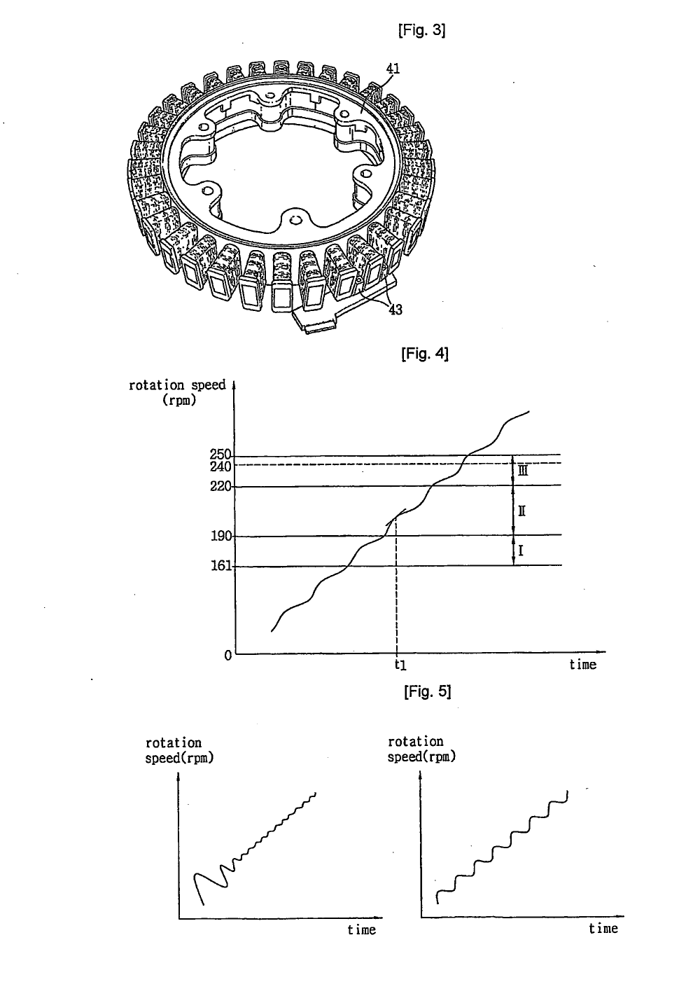

FIG. 2 is a configuration view illustrating one example of a washing machine capable of conducting a spin drying method in accordance with the present invention. The washing machine 100 includes a tub 10 for containing wash water, a drum 20 rotatably positioned in the tub 10, for containing laundry, a control unit 30 for controlling the whole washing processes including the rotation of the drum 20, a motor 40 for rotating the drum 20, and a water supply passage 60 for supplying wash water into the tub 10. The tub 10 includes a drainage passage 11. In the spin drying, the wash water separated from the laundry and discharged from the drum 20 is collided with the tub 10 and drained off through the drainage passage 11. The control unit 30 controls the whole washing processes including water supply, washing, rinsing and spin drying. To this end, the control unit 30 opens and closes the drainage passage 11 and the water supply passage 60, and controls the rotation of the drum 20, laundry quantity sensing, and measurement of an allowable unbalance value. The motor 40 includes a stator 41 and a mover 42 to rotate the drum 20. The stator 41 has a sensor 43 (for example, a hall sensor) for measuring a rotation amount of the drum 20. The measured rotation amount of the drum 20 is transferred to the control unit 30 for use in the control of the washing machine. One example of the sensor has been disclosed in Korea Laid-Open Patent Gazette 2005-067914 (refer to FIG. 3). The hall sensor 43 is fitted into the stator 41. Preferably, a circulation passage 12 is provided at the drainage passage 11, for circulating wash water into the drum 20. A water level detection unit 13 for measuring a water level of wash water is provided at one side of the drainage passage 11. One example of the water level detection unit has been disclosed in Korea Laid-Open Patent Gazette 2004-107651. Accordingly, wash water is circulated through the circulation passage 12, and absorbed by the laundry in the drum 20. It is detected by the water level detection unit 13 and transferred to the control unit 30. The control unit 30 supplies water into the tub 10 by opening the water supply passage 60, and counts a number of times of water supply.

FIG. 4 is a graph showing one example of a method for sensing unbalance in an acceleration period in accordance with the present invention. As shown in FIG. 4, the drum 20 is accelerated in the acceleration period. According to the present invention, when the tub 10 elastically supported by an external frame is resonated at about 240 rpm, the acceleration period is divided into three periods, I period (161 to 190 rpm), II period (191 to 220 rpm) and HE period (221 to 250 rpm). Continuation of the acceleration is determined by judging whether a sum of gradient values in each point t₁ (or a sum of variation degrees of the rotation speed in each point) exceeds a set value in each of the three periods. Meanwhile, the washing machine has a resonance rotation speed at about 240 rpm. Therefore, it is preferable to prevent shaking of the tub 10 in advance by setting a strict (small) allowable unbalance value from I period to HE period (namely, setting a small value that the sum of the variation degrees of the rotation speed must not exceed).

On the other hand, according to the present invention, continuation of the acceleration can be determined by setting one period and checking the variation degree of the rotation speed. However, as shown in FIG. 5, even if the sums of the variation degrees of the rotation speed are identical in the left and right graphs, the acceleration must be stopped in the left graph, but needs not to be stopped in the right graph. Therefore, the acceleration period is preferably divided into a plurality of periods to consider the variation degrees of the rotation speed.

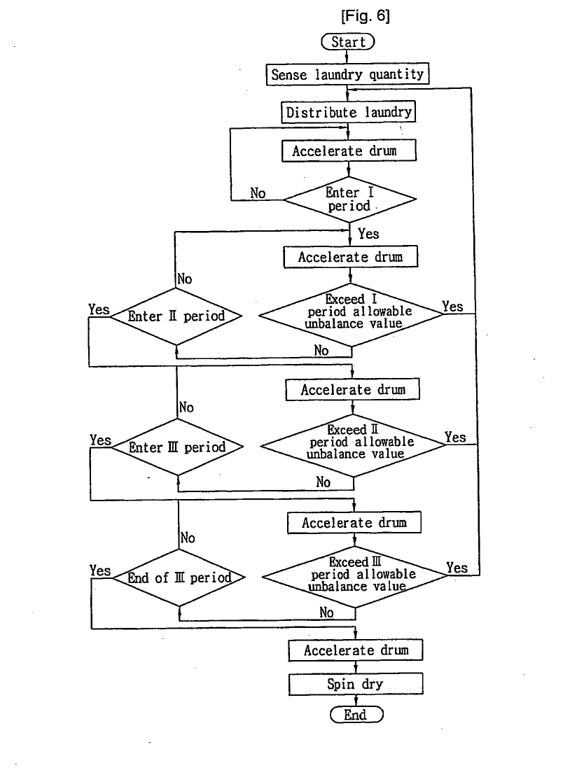

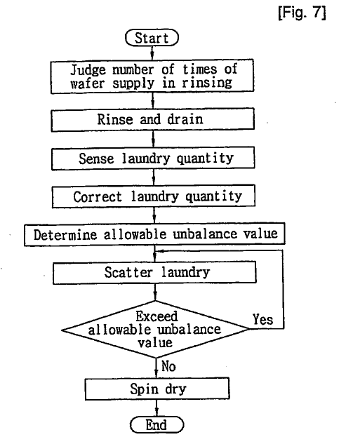

FIG. 6 is a flowchart showing one example of a spin drying process in accordance with the present invention. A quantity of laundry is sensed, the laundry is scattered, and a drum is accelerated to enter I period. While the drum is accelerated, if an unbalance value exceeds an I period allowable unbalance value, the laundry is scattered again, and if the unbalance value does not exceed the I period allowable unbalance value till II period, the drum enters II period. When the drum is continuously accelerated, if the unbalance value exceeds an II period allowable unbalance value, the laundry is scattered again, and if the unbalance value does not exceed the II period allowable unbalance value till III period, the drum enters III period. While the drum is accelerated, if the unbalance value exceeds an III period allowable unbalance value, the laundry is scattered again, and if the unbalance value does not exceed the III period allowable unbalance value till the end of III period, the drum is continuously accelerated to conduct the spin drying. The above example is nothing but an example of spin drying the laundry. That is, the spin drying can be variously performed. For example, the spin drying and the unbalance sensing below a predetermined rotation speed can be carried out between the laundry scattering and the acceleration period of the present invention.

FIG. 7 is a flowchart showing one example of the spin drying method in accordance with the present invention. A number of times of water supply in rinsing is judged, rinsing and draining are conflicted, and a quantity of laundry is sensed. The sensed quantity of the laundry is corrected by using the number of times of water supply in rinsing. For example, the quantity of the laundry is sensed as single, small or large. In the case of the single, if the number of times of water re-supply is equal to or less than ‘1’ the quantity of the laundry is judged as single, if the number of times of water re-supply is ‘2’ or ‘3’ the quantity of the laundry is judged as small, and if the number of times of water re-supply is equal to or larger than ‘4’ the quantity of the laundry is judged as large. In addition, in the case of the small quantity, if the number of times of water re-supply is equal to or less than ‘1’ the quantity of the laundry is judged as small, if the number of times of water re-supply is ‘2’ or ‘3’ the quantity of the laundry is judged as small, and if the number of times of water re-supply is equal to or larger than ‘4’ the quantity of the laundry is judged as large. In the case of the large quantity, if the number of times of water re-supply is equal to or less than ‘2’ the quantity of the laundry is judged as large, if the number of times of water re-supply is ‘2’ or ‘3’ the quantity of the laundry is judged as large, and if the number of times of water re-supply is equal to or larger than ‘4’ the quantity of the laundry is judged as large. That is, when the number of times of water re-supply is ‘2’ or ‘3’ the single is corrected into the small quantity, and when the number of times of water re-supply is equal to or larger than ‘4’ the single and the small quantity are corrected into the large quantity. Thereafter, an allowable unbalance value is determined according to the corrected quantity of the laundry, and the laundry is scattered. If an unbalance value exceeds the allowable unbalance value, the laundry is scattered again, and spin dried.

1. A spin drying method using a tub provided with a drainage passage, a drum rotatably positioned in the tub, for containing laundry, and a water supply passage connected to the tub, for supplying wash water into the tub, the spin drying method comprising:
a first step for accelerating the drum containing the laundry from a first rotation speed to a second rotation speed for spin drying, the first step including a de- termination process for determinating continuation of the acceleration in at least one period included in the rotation speed range ranging from the first rotation speed to the second rotation speed; and
a second step for finishing the spin drying and stopping the rotation of the drum.

2. The spin drying method of claim 1, wherein the determination process is performed in at least two periods.

3. The spin drying method of claim 2, wherein the determination process is performed in the at least two periods by using different determination references.

4. The spin drying method of claim 1, wherein the rotation speed range comprises a resonance rotation speed of a spin dryer.

5. The spin drying method of claim 1, wherein the determination process determinates continuation of the acceleration by using a variation amount of the rotation speed.

6. The spin drying method of claim 1, further comprising a step for judging a number of times of water supply using the water supply passage as a prior step to the first step, wherein the first step spin dries the laundry with an available unbalance value reflecting the judged number of times of water supply.

7. The spin drying method of claim 6, further comprising a step for judging a quantity of laundry prior to the first step.

8. The spin drying method of claim 7, further comprising a step for draining off wash water through the drainage passage prior to the step for judging the quantity of the laundry.

9. The spin drying method of claim 7, wherein the step for judging the quantity of the laundry comprises a laundry quantity correction process for correcting the quantity of the laundry by using the judged number of times of water supply.

10. The spin drying method of claim 9, wherein, when the judged number of times of water supply is over a pre-determined value, the laundry quantity correction process corrects the judged quantity of the laundry into a greater quantity.

11. A spin drying method using a tub provided with a drainage passage, a drum rotatably positioned in the tub, for containing laundry, and a water supply passage connected to the tub, for supplying wash water into the tub, the spin drying method comprising:
a step for judging a number of times of water supply using the water supply passage; and
a spin drying step for spin drying the laundry with an allowable unbalance value reflecting the judged number of times of water supply.

12. The spin drying method of claim 11, further comprising a step for judging a quantity of laundry prior to the spin drying step.

13. The spin drying method of claim 12, further comprising a step for draining off wash water through the drainage passage prior to the step for judging the quantity of the laundry.

14. The spin drying method of claim 12, wherein the step for judging the quantity of the laundry comprises a laundry quantity correction process for correcting the quantity of the laundry by using the judged number of times of water supply.

15. The spin drying method of claim 14, wherein, when the judged number of times of water supply is over a pre-determined value, the laundry quantity correction process corrects the judged quantity of the laundry into a greater quantity.
